(19) United States
(12) Patent Application Publication
(10) Pub. No.: US 2019/0163979 A1
(43) Pub. Date: May 30, 2019

(54) SYSTEMS AND METHODS FOR MANAGING ELECTRONIC ATHLETIC PERFORMANCE SENSOR DATA

(71) Applicant: HEED, LLC, New York, NY (US)

(72) Inventors: Oliver Johannson, Darmstadt (DE); Mario Tuerke, Darmstadt (DE); Guy Schiftan, New York, NY (US); Jason Stark, Homdel, NJ (US); Matania Kochavi, Caesaria (IL); Danna Rabin, New York, NY (US); Boris Kizelshteyn, New York, NY (US); Lawrence Norman, New York, NY (US)

(21) Appl. No.: 16/205,004

(22) Filed: Nov. 29, 2018

Related U.S. Application Data
(60) Provisional application No. 62/592,337, filed on Nov. 29, 2017.
(60) Provisional application No. 62/592,357, filed on Nov. 29, 2017.

(51) Int. Cl. G06K 9/00; G06K 9/62; A63B 71/06

(52) U.S. Cl. CPC G06K 9/00724; A63B 71/06; G06K 9/00342; G06K 9/6215

(57) ABSTRACT

A sensor system and analytics package that delivers a professional athlete's routine, drill, and/or move to an end user. The sensor system includes a network of physical devices embedded with electronics, software, sensors, actuators, and network connectivity to enable the sensors to connect and exchange data. In some embodiments, the sensor system can also be used to providing an engaging sports simulation where the user can choose to make different decisions during major sporting events and see their outcomes playout.

### CROSS-REFERENCE TO RELATED APPLICATIONS

This application is a non-provisional of, and claims the benefit of, U.S. Provisional Patent Application No. 62/592,337, filed Nov. 29, 2017, and U.S. Provisional Patent Application No. 62/592,357, filed Nov. 29, 2017, which applications are hereby incorporated herein by reference in their entirety for all purposes.

### FIELD

The present disclosure relates generally to managing electronic sensor data and more specifically, but not exclusively, to data processing systems for receiving and processing electronic data from accelerometers fitted on athletes, such as in gloves for combat sports.

### BACKGROUND

A fan watching a sporting event often wonders how well they would perform a move they just saw performed by a professional athlete. For example, a baseball fan often wonders if they can hit a fast ball from their favorite professional pitcher. As another example, fans of combat sports or other competitive contact sports wonder how they would fare in the ring against their favorite professional athlete. Conventional systems do not enable the user to quantify the performance of the fan against that of a star athlete. For example, conventional systems do not enable the user to measure their own performance and track it against the performance of a star athlete. Among other challenges, conventional systems do not semantically associate video frames from a user with video frames of the star athlete. Conventional systems do not provide sensor data to evaluate the performance of the star athlete.

Furthermore, conventional video games and simulations of sporting events are either entirely fictitious or rely on generalized and derivative profiles measures. However, even generalized and derivative profiles measured to describe real world athletes and the ensuing action are also typically fictitious.

In view of the foregoing, a need exists for an improved athletic performance system and method for generating quantitative comparisons and predictive simulations from sensor data capturing the performance profile of professional athletes in an effort to overcome the aforementioned obstacles and deficiencies of conventional entertainment systems.

### BRIEF DESCRIPTION OF THE DRAWINGS

FIG. 1 is a top-level block diagram illustrating one exemplary embodiment of an athletic performance measurement system;

FIG. 2 is a top-level flow diagram illustrating another exemplary embodiment of the athletic performance measurement system of FIG. 1;

FIG. 3 is a top-level flow diagram illustrating one exemplary embodiment of the venue and analytics engine of FIG. 1;

FIG. 4 is a top-level flow diagram illustrating another exemplary embodiment of the athletic performance platform of FIG. 1;

FIG. 5 is a top-level flow diagram illustrating another exemplary embodiment of the athletic performance platform of FIG. 4; and

FIG. 6 is a screenshot illustrating one exemplary embodiment of a performance metric comparison of two athletes using the athletic performance management system of FIG. 1.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

Since currently-available entertainment systems are deficient because they fail to provide fans with a lifelike simulation or quantitative relative performance, an athletic performance system that enables a user to see how their own performance of a given sports move or routine compares with that of a professional athlete can prove desirable and provide a basis for a wide range of data metrics applications, such as the ability for fans to view a side by side video comparison of their performance against the performance of their favorite professional athlete. Furthermore, the athletic performance system can allow the predication of the sequence of events that follow an alternative action when one or more variables are changed through a simulation can also provide desirable and provide a basis for applications such as allowing fans and users to change the outcome of real matches as if the athlete themselves had made different choices in the execution of the game. These results can be achieved, according to one embodiment disclosed herein, by an athletic performance system 100.

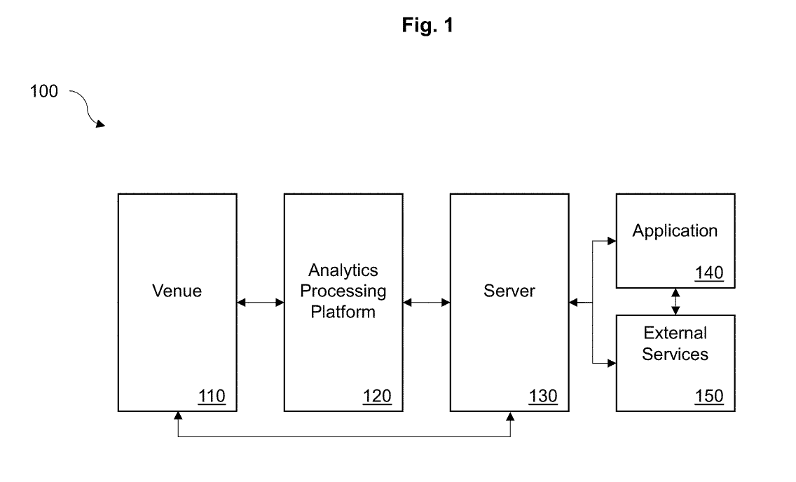

Tuning to FIG. 1, the athletic performance system 100 includes a number of sensor applications, for example, at a venue 110, for capturing the physical, emotional or behavioral aspects of an action, for each of two people, and providing a measure of the similarity between the two actions. By way of example, the sensor applications can include the sensors disclosed in commonly-assigned co-pending U.S. patent application [sensor application], filed concurrently, the disclosure of which is hereby incorporated by reference in its entirety and for all purposes. The sensor application systems can include one or more sensors distributed throughout the venue 110 and a sensor collection and analysis component, such as an analytics processing platform 120 as shown in FIG. 1. The sensor applications communicate with a central server 130 to deliver one or more data streams representing at least a first athlete. In some embodiments, the sensor applications also measure the actions of a second athlete (e.g., the user or fan) in addition to the first athlete. A similarity measure between the user/fan and the professional athlete may be accessed using a mobile application that can wirelessly communicate with the central server.

In some embodiments, the central server 130 includes a communication system for receiving the sensor application data over a wireless network. The central server 130 can support one or more applications 140 and/or communicate with external services 150 described herein. Although described as a central server 130, those of ordinary skill in the art would understand that the central server 130 can be hosted on a cloud-service provider to support a platform for the performance management system 100.

Suitable wireless communication networks can include any category of conventional wireless communications, for example, radio, Wireless Fidelity (Wi-Fi), cellular, satellite, and broadcasting. Exemplary suitable wireless communication technologies include, but are not limited to, Global System for Mobile Communications (GSM), General Packet Radio Service (GPRS), Code Division Multiple Access (CDMA), Wideband CDMA (W-CDMA), CDMA2000, IMT Single Carrier, Enhanced Data Rates for GSM Evolution (EDGE), Long-Term Evolution (LTE), LTE Advanced, Time-Division LTE (TD-LTE), High Performance Radio Local Area Network (HiperLAN), High Performance Radio Wide Area Network (HiperWAN), High Performance Radio Metropolitan Area Network (HiperMAN), Local Multipoint Distribution Service (LMDS), Worldwide Interoperability for Microwave Access (WiMAX), ZigBee, Bluetooth, Flash Orthogonal Frequency-Division Multiplexing (Flash-OFDM), High Capacity Spatial Division Multiple Access (HC-SDMA), iBurst, Universal Mobile Telecommunications System (UMTS), UMTS Time-Division Duplexing (UMTS-TDD), Evolved High Speed Packet Access (HSPA+), Time Division Synchronous Code Division Multiple Access (TD-SCDMA), Evolution-Data Optimized (EV-DO), Digital Enhanced Cordless Telecommunications (DECT) and others.

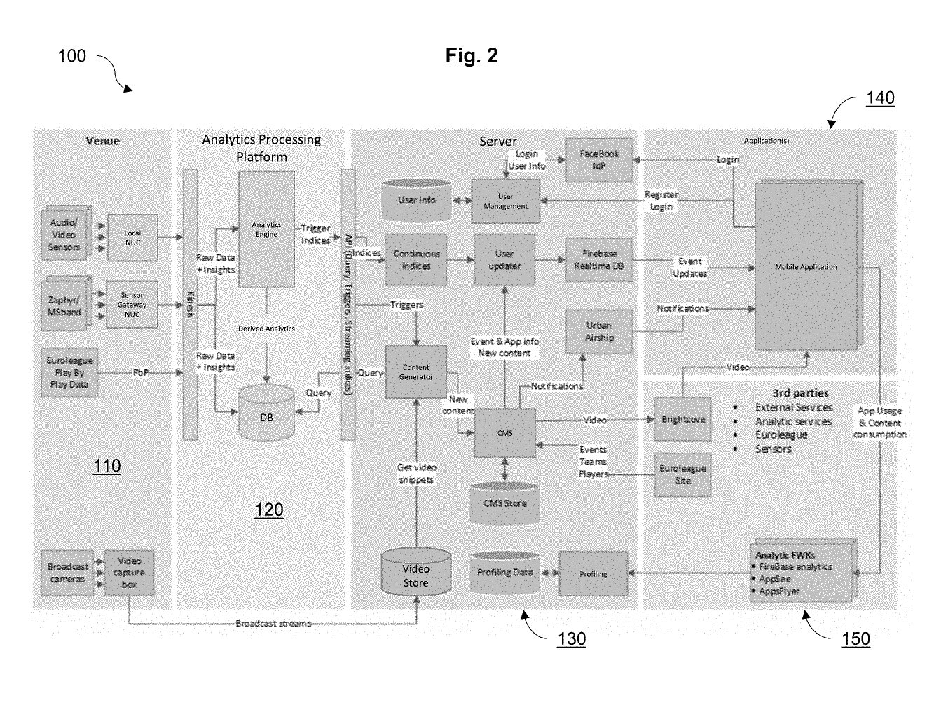

For example, with reference to FIG. 2, facilities instrumented with video and/or Internet of Things (IoT) sensors capture the performance profile of a professional athlete during the course of a match or training session. The venue 110 can include any number of audio/video sensors and Next Unit of Computing (NUC) systems. The data received from the various sensors are provided to an analytics engine and processed by the one or more local NUCs to render insights into the contents of the audio and video sensor data as described herein. A given move, drill or routine is editorially selected to be of interest to fans and delivered to them with the option to match up, such as via the applications 140. For example, the sensors can be used within the venue 110 to capture dribbling moves, shots, celebrations, passes, saves, and so on in a soccer game.

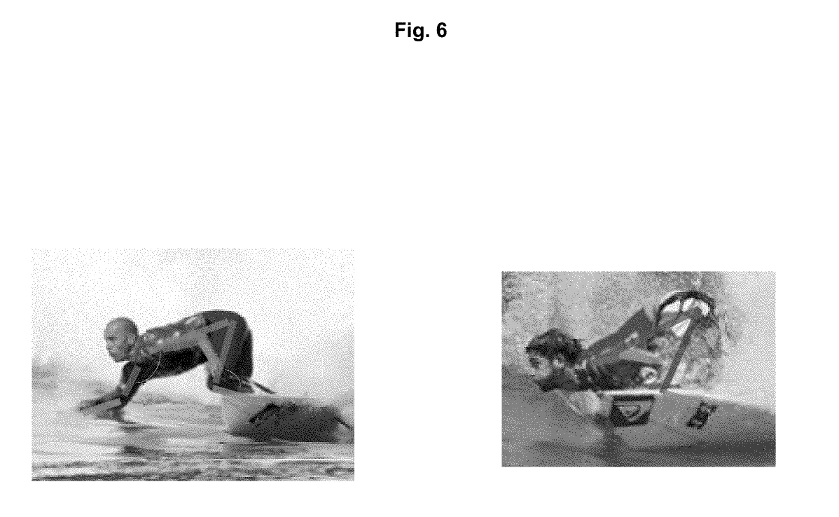

The fans then capture themselves attempting the same move, drill or routine using the camera and other sensors (e.g., internal motion and audio sensors) available to the mobile application 140 on their phone. The athletic performance system can receive the data for comparison at the platform 130 to then provide a side by comparison of the performance of the athlete and the fan, such as shown in FIG. 6, quantifying the difference between them. As previously discussed, additional information on the sensors are disclosed in commonly-assigned co-pending U.S. patent application [sensor application], filed concurrently, the disclosure of which is hereby incorporated by reference in its entirety and for all purposes.

In some embodiments, the wireless communications between the subsystems of the athletic performance system 100 can be encrypted, as may be advantageous for secure applications. Suitable encryption methods include, but are not limited to, internet key exchange, Internet Protocol Security (IPsec), Kerberos, point-to-point protocol, transport layer security, SSID hiding, MAC ID filtering, Static IP addressing, 802.11 security, Wired Equivalent Privacy (WEP), Wi-Fi Protected Access (WPA), WPA2, Temporal Key Integrity Protocol (TKIP), Extensible Authentication Protocol (EAP), Lightweight Extensible Authentication Protocol (LEAP), Protected Extensible Authentication Protocol (PEAP), and the like. Encryption methods specifically designed for mobile platform management systems may also be suitable.

Thus, existing wireless technologies for use by current telecommunications endpoints can be readily adapted for use by the sensor applications and central server. For example, by outfitting each combat glove with a wireless card like those used for mobile phones, or other suitable wireless communications hardware, the combat gloves can easily be integrated into existing networks. Alternatively, and/or additionally, proprietary communications hardware can be used as needed.

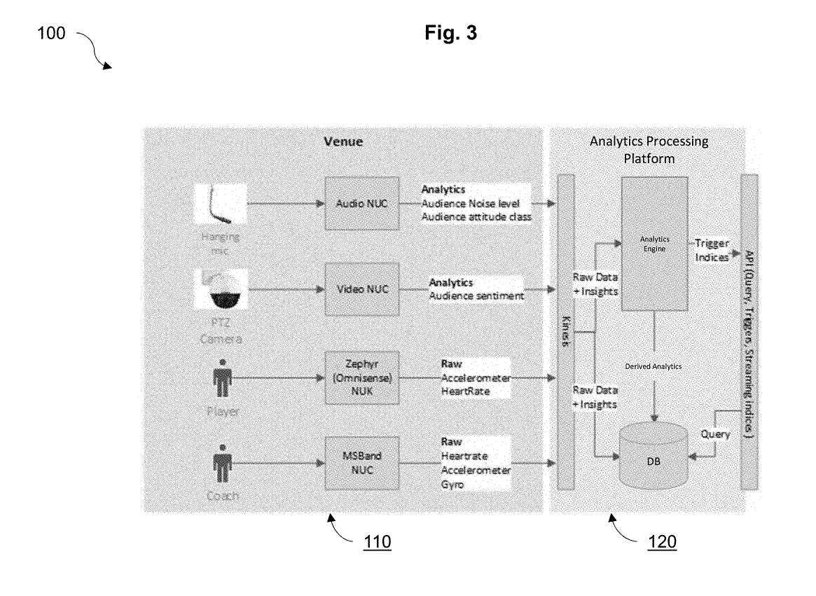

In some embodiments, the sensor applications can include any number of sensors equipped on athletic equipment. Turning to FIG. 3, exemplary sensors within the venue 110 and the distributed ledger 120 are shown. The sensor systems can capture audience video and audio, player acceleration, athlete pace, player heartrate, coach acceleration, coach sentiment, coach heartrate, and so on as desired. In some embodiments, the athlete data can be stored in a relational database entry that includes a playerID, a jumpIndex, a jumpHeight, a jumpDuration, a jumpAcceleration, timestamp, stepSpeed, stepImpact, energyIndex, and so on. For example, a professional basketball player can wear a motion sensor fitted with an ultra-wideband (UWB) wireless interface communicating with the analytic processor over a wireless data network. The UWB interface can communicate data recorded of the professional basketball player while performing a spin move while dribbling and dunking the basketball. In some embodiments, the motion sensor can provide streaming data in the form of a time series of values for each dimension of data. By way of example, for three axes of acceleration and three axes or rotation, the sensors can provide six channels of streaming data. These six channels can be compared using analytics that match the trends in the data from the reference frames of a video (e.g., representing the professional athlete) to those in the reference frames of a comparison video (e.g., representing the user). The difference between the two frames can be used to provide a measure of similarity. In other words, a fan watching the professional basketball player also can be equipped with sensors (e.g., sensors from their mobile device) and perform the same move. The mobile device can connect to the analytic processor (e.g., the analytics engine of the distributed ledger 120) over the wireless data network and provide data regarding the same spinning dribble and dunk. The analytic processor generates metrics that describe the moves of the respective professional and amateur. The two metrics can be compared to produce a similarity measure that is communicated to the fan.

The sensor applications used by the fan and the professional can be the same type of sensor systems and/or include a combination of different (or unique) sensors. In IoT sensor systems, a wearable physical sensor is often mounted to the body of a person. This IoT sensor measures a physical aspect of the person, such as location, motion or biometric data. Location sensors can include wearable GPS sensors, UWB indoor sensors, and/or radio frequency identification (RFID) sensors. Motion sensors can include accelerometers, gyroscopes and magnetometers. Biometric sensors can include heartrate/heartrate variability, breathing, temperature, sweat, skin conductance, or electrically-determined muscle and brain activity.

Additionally and/or alternatively, video and audio data can be collected using cameras and microphones, respectively. Video and audio systems can be deployed for the purposes of collecting video and audio data during an event, or for general surveillance purposes, and used as inputs incidental to the event.

In the basketball example, the basketball player wears a UWB motion sensor that transmits its motion data to a wireless access point. The fan carries a smartphone in his pocket, running a mobile application that connects to accelerometers in the smartphone.

As previously discussed, data from the sensor applications are made available using a wireless communications network. This network might be a closed data network, virtual private network, open network, Internet, and/or IoT. The communications network might be established using one, individually, or a combination of more than one of wireless networks. Access points for wireless interfaces can be included in the communications system.

The communications network connects the data sources (e.g., sensor applications) to the data processing facilities (e.g., the central server 130). In the basketball example, the sensor on the basketball player communicates its data to a nearby access point, which communicates across a virtual private network over the Internet to the analytic processing system. The mobile applications that runs on the fan's smartphone communicates the sensor data through the cellular network over the Internet to the analytic processing system.

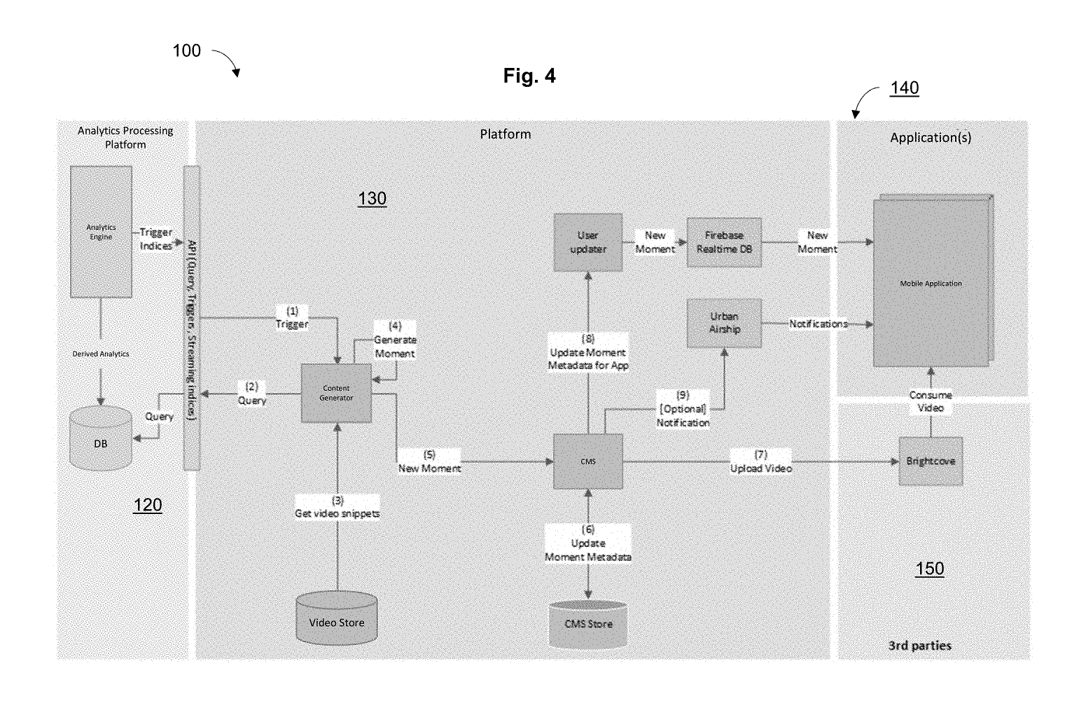

In some embodiments, as shown in FIG. 4, the platform 130 can look for various triggers to determine whether a given move, drill, or routine should be selected for presentation. The triggers can include a predetermined move height, change in score, a predefined sporting event, a noise threshold, and so on, such as shown in the table below:

Specification

| Moments | Sensors | Analytics | Triggers | Context |
|---|---|---|---|---|
| Interesting | Player motion | Jump Analytic | JumpHeight above | Accumulated Jump |
| Dunks | sensor, Play- | | 60 cm, Play-by-Play API | Height and Duration |
| | by-Play API | | indicates a Two Pointer | statistical distribution |
| | | | within 2 seconds | |
| Super | Shooting | Player/Team | Shooting Chart API | PlayerEnergy statistical |
| Energetic | Chart API | Energy | indicates a Fast Break | distribution |
| Fast Break | | | point | |
| Game Winner | Play-by-Play | Situation | Any change of lead | Fan Excitement statistical |
| | API | Pressure | within the final 2 | distribution |
| | | | minutes of game time | |
| Lead change/ | Play-by-Play | Team Energy | Play-by-Play API | Energy Index |
| comeback | API | | indcates a Two Pointer, | |
| | | | followed by scoring | |
| | | | team ahead by one | |
| | | | point, or Three Pointer, | |
| | | | followed by scoring | |
| | | | team ahead by one or | |
| | | | two points | |
| Fan Chanting/ | Audience | Noise, Audio | NoiseIndex above 8 on | NoiseLevel statistical |
| Singing in | microphones | Classification | [0, 10] scale, Audio | distribution |
| Unison | | | Classification is | |
| | | | ‘Chanting’ | |
| Player with | Player motion | Explosiveness, | ExplosivenessIndex | Players explosiveness. |
| great | sensor, Play- | Player Status | above 8 on [0, 10] scale, | |
| explosive | by-Play API | | PlayerStatus is | |
| move | | | ‘Playing’, Pbp indicates | |
| | | | 2 points or assist | |
| Buzzer | Player motion | Situation | Play-by-Play API | Situation Pressure index |
| Beater | sensor, Play- | Pressure, | indicates a Two Pointer, | |
| | by-Play API | | followed by scoring | |
| | (time and | | team tied or leading by | |
| | score) | | one point, or Three | |
| | | | pointer, followed by | |
| | | | scoring team tied or | |
| | | | leading by one or two | |
| | | | points, within 3 seconds | |
| | | | of end of game period | |
| Coaches' IoT | WorldGraph | | End of game | CoachAgitationLevel, |
| leaderboard | API, | | | EnergyLevel within game |
| | Historical | | | based on EL history, Number |
| | Play-by-Play | | | of Steps (plus total EL win |
| | API | | | record, total career record, |
| | | | | win percentage, nationality, |
| | | | | short bio, etc.) |
| Fans IoT | WorldGraph | | End of game | Time spent cheering vs. |
| Leaderboard | API, | | | booing (classification), |
| | Historical | | | Crowd Emotion, |
| | Play-by-Play | | | Audience Attitude per |
| | API | | | stadium within season to |
| | | | | date; peak NoiseLevel |
| | | | | reached throughout the |
| | | | | season |
| Heat Check/ | Play-by-Play | Player Energy | Play-by-Play API | PlayerEnergy index |
| Hot Hand | API | | indicates 3 successful | |
| | | | Two or Three Pointers | |
| | | | by a player within 3 | |
| | | | minutes, without a | |
| | | | Missed 2 or 3 Pointer | |
| Fan | Audience | Noise, Audio | NoiseIndex below 4 on | NoiseLevel statistical |
| Depressed | microphones, | Classification, | [0, 10] scale, AvgSad | distribution |
| | video camera | Crowd | above 0.7 and/or | |
| | | Emotion | AvgHappy below 0.3 | |
| | | | on [0, 1] scale | |
| Perfect Half | Player energy | | Player scored at least 4 | PlayerEnergy index |
| | | | shots without a missed | |
| | | | field goal | |
| Games IoT | WorldGraph | | End of game | |
| leaderboard | API, | | | |
| | Historical | | | |
| | Play-by-Play | | | |
| | API | | | |
| IoT HEED | WorldGraph | | End of game | Top performer of the |
| top performer | API, | | | game, of the season |
| of the game | Historical | | | |
| | Play-by-Play | | | |
| | API | | | |
| IoT game | | | End of game | |
| highlights | | | | |
| Players IoT | WorldGraph | | End of game | Overall average |
| Leaderboard | API, | | | PlayerEnergy per game, |
| | Historical | | | cumulative JumpHeight, |
| | Play-by-Play | | | average StepSpeed, |
| | API | | | Player Efficiency |
| | | | | throughout the season, |
| | | | | possibly report peak |
| | | | | levels of each metric |
| | | | | within season to date |
| Interesting | Player motion | Jump Analytic, | Play-by-Play API | Scale of Jump, |
| Blocks | sensor, Play- | Aggression | indicates Blocked Shot | aggression and |
| | by-Play API | index, | | explosiveness |
| | | Explosiveness. | | |
| Fan Favorite/ | WorldGraph | | End of game | Accumulated |
| Loyalty of | API, | | | FavoredPlayerIndex |
| the game | Historical | | | throughout game, |
| | Play-by-Play | | | |
| | API | | | |
| Perfect | Player motion | Iciness, Player | Player scored at least 8 | Iciness + Player energy |
| Game | sensor, player | Energy | shots without a missed | index |
| | heart rate | | field goal | |

The fans then capture themselves attempting the same move, drill or routine using the camera and other sensors (e.g., inertial motion and/or audio sensors) available to the mobile application 140 on their phone. In other words, once an athlete triggers that a specific move is of interest, the performance measurement system can generate a video file and metadata relating that professional move. The video and metadata can include player/coach information, details about the moment (e.g., height of the jump, energy level of the athlete) and original video from a broadcast feed of the venue 110. A content management system stores the video and metadata, indexes the data, and enables content retrieval.

As discussed, the central server 130 can include the analytic processing system. The collected data are wirelessly communicated to the analytic processing system. The analytic processing system includes one or more analytic, machine learning, data mining and artificial intelligence methods. In some embodiments, machine learning methods include Hidden Markov Models, Random Forests, Unsupervised Clustering, Anomaly Detection and others. Analytics include peak detection, time-series analysis, computer vision, and data fusion. Data mining methods include correlation and statistical analysis. Artificial Intelligence methods include Deep Learning and Logic Modeling. Using these methods, selected characteristics of a time-series data source (e.g., video, audio, acceleration, rotation, position, and so on) are extracted for further processing. The selected characteristics are used to generate analytic signatures for a reference athlete and a user. These analytic signatures are compared to produce a similarity score. These methods produce a comparison between the actions of the two persons, as represented in the data collected by the sensor systems.

The processing system may be a single collocated assembly, or a distributed system interconnected by data communications networks. These may be implemented as physical hardware, or obtained virtually using cloud computing models.

In the basketball example, the analytic processing system is implemented as a cloud-based server cluster, residing in the datacenter of a cloud service provider.

The athletic performance system can determine the similarity between two complex sequences of sensor data values, producing a simple, low-complexity measure. This can be accomplished by representing the two action sequences as a time-series vector, and then performing a measure of the overlap of the two vectors. Stated in another way, a time series representing the reference athlete (e.g., professional athlete) can be compared with a time series representing the user to produce a single score, or collection of scores.

In some embodiments, the reference and the user data can include video data that represents the athlete performing a signature move and video data that represents the user attempting to replicate that same move. In each frame of the video, joint positions of each respective athlete can be determined using computer vision methods.

Determining joint positions can include any process described herein. For example, determining the joint positions from a video source can include segmentation and classification of image elements for each video frame. For a first video of a first user, the first user is distinguished from the background images. In other words, the first user is distinguished from the additional noise of the image. This identifies a collection of pixels in the image that are all associated with the person whose signature move is being analyzed.

Once the image is segmented, the image forms that represent different body parts are identified. This process includes supervised machine learning models that distinguish arms, legs, torso, head, facial features, and so on. The relationships between these identified elements are determined, so that the location of joints between body parts are returned. In some embodiments, the locations are determined within a reference frame internal to the video frame. Therefore, the relative location of different body parts to a specific frame reference can be used across video frames. By way of example, the vertical component of joint locations of a video frame can be used to ignore relative angle between the subject and the camera.

A time series of joint positions describes the movements of the athlete. This sequence of joint positions is used to compare to the video submitted by the user. For instance, the joint positions extracted from the video submitted by the user can be compared to those of the reference athlete to determine a similarity between the respective time-series of joint positions. This initial similarity measure describes the comparison of each frame in one video to a frame in a second video. This set of initial similarity measures can be aggregated across all frames in the video to produce a single comprehensive similarity score described herein.

This is accomplished by comparing the relative positions of the joints, between the reference and user. For instance, the frames from one video can be compared to frames in a second video to determine which reference frame is closest to which user frame. This produces an association between one video sequence and the other.

After this association is known, the locations of the body joints of the reference athlete in one frame can be compared to the locations of body parts of the user in the associated frame. This comparison can be made on the basis of separation of joints from each other, or the relative heights of the joints, relative to each other. It can also be done on the basis of the relative angles of the limbs, with respect to each other.

Accumulating metrics from one frame to the next yields a cumulative measure of the similarity between the reference video of the athlete and the video submitted by the user. This measure of similarity is then reported to the user as a similarity score. In some embodiments, the cumulative similarity score can be obtained using a summation of all individual similarity scores or a product of the individual scores.

In some embodiments, the comparison includes determining the product of the two time-series vectors, for each moment in time, and determining the sum of the resulting product. If the two time-series are highly correlated with each other, then this result will be large. If they are not, then the result is a small number. This value represents the measure of similarly.

As an example, the reference athlete can wear a motion sensor that measures acceleration and rotation. The time series of data from each of the three axes of reach sensor are recorded as the athlete performs a signature move. These data capture the significant aspects of the signature move, and characterize it using a simpler representation of the time series. For example, data derived from three axes of acceleration for an athlete can produce a single magnitude of acceleration. This advantageously simplifies the three values for an instant of time into a single value.

The time series data are compared in a similar manner as that of the sequence of joint positions discussed herein. Each represents the signature move in a simpler, lower-dimensional form.

First, an alignment of the time series is performed, in order to associate times in the reference data with times in the user-submitted data. In some embodiments, the alignment of the time series includes comparing individual time series data points or frames from both the first and second videos. While maintaining the sequential order of each of the sequence of video frames, the alignment includes identifying pairs of data points in the first video with similar data points from the second video to maximize a similarity score. In a preferred embodiment, the similarity score is maximized using a best fit of the sequential data points from the first video with that of the second video.

Next, the similarity of the associated data is determined using a correlation measure. The values of the acceleration and rotation are compared to determine the distance between them during each moment of time. This can be done by treating the three values of acceleration and the three values of rotation as a six-dimensional vector. The projection of one vector onto the other measures how similar the data are. This similarity is accumulated across the duration of the data. The result is a similarity measure that is reported to the user as the similarity score.

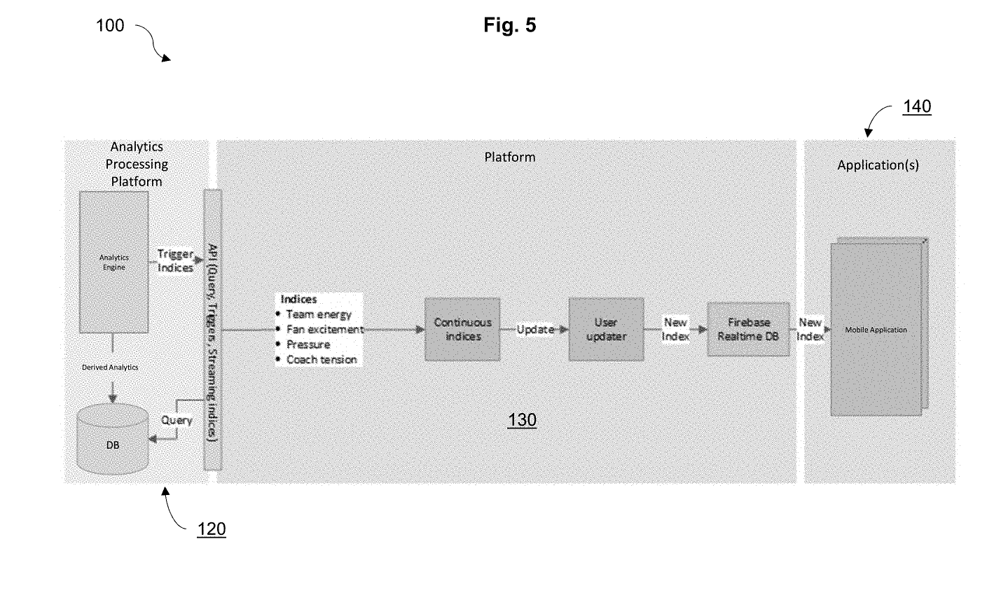

As shown in FIG. 5, the performance measurement system 100 also maintains a list of continuous indices. For example, facial expressions, team energy, fan excitement, pressure, coach tension can be maintained. These continuous indices can be used for identifying exciting moments in a sporting event, and for annotating content to report the characteristics of actions and/or behaviors. For example, the facial expression, as exhibited in video data can be used to produce a time series of emotional state data. The level of joy, for instance, can be measured over time. Using a reference video of a star athlete, having just scored a goal in a soccer match, the facial expression of joy can be measured over time. The same can be measured in a video submitted by a user. These two time series can be compared, to produce a similarity measure that is reported to the user as a similarity score.

In the basketball example, the motion data that represents the spinning dribble is directly compared between the basketball player and fan, to determine the degree of similarity between the player and fan. The motion data representing the dunk is also compared, to determine how high the fan jumped, relative to the player. These two comparisons are combined to produce a single numeric measure.

In some embodiments, the comparison measure is made available to one or both of the persons involved in the comparison. This may be delivered in one of several ways, including presentation within a mobile application, web page, email, text message, and/or push notification.

Advantageously, the athletic performance system provides a quantitative comparison between a professional athlete's and a fan's performance of a certain move, routine, or drill and can provide strategic value in the fields of entertainment, training and fitness. In entertainment, the ability to quickly—and without specialized equipment—produce such a side by side comparison creates a unique moment that is shareable in person and on social media. The system advantageously provides improved training and fitness for inspiring the fan to repeatedly perform routines like the professional athlete to see both how they match up in that moment and how much they have improved, (i.e., simulated the performance profile of the professional athlete).

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A computer-implemented method for comparing athletic performance metrics, comprising:
receiving a first video stream of a first athlete;
receiving a second video stream of a second athlete;
extracting selected characteristics from the received first video stream;
extracting the selected characteristics from the received second video stream;
determining a relationship between the extracted characteristics of the first and second video streams; and
determining a similarity score between the first athlete and the second athlete by comparing the determined relationship.

2. The method of claim 1, wherein said determining the relationship between the extracted characteristics comprises generating a first time series of positions of selected body parts of the first athlete and a second time series of the selected body parts of the second athlete, said determining the relationship is based on the first and second time series.

3. The method of claim 2, wherein said generating the first time series and the second time series comprises generating a first time series of joint positions of the first athlete and generating a second time series of joint positions of the second athlete.

4. The method of claim 1, wherein said receiving a first video stream of a first athlete further comprises receiving sensor data from sensors worn on the first athlete.

5. The method of claim 1, further comprising extracting images of the first athlete from the received first video stream to remove background images, the extracted images of the first athlete used for said extracting selected characteristics.

6. The method of claim 1, further comprising aligning the received first and second video stream to a common time series.

7. The method of claim 1, further comprising maintaining a derived indices, the derived indices being used to identify the selected characteristics for said extracting.

8. A computer-implemented method for comparing athletic performance metrics, comprising:
receiving a first data stream of sensor data of a first athlete;
receiving a second data stream of sensor data of a second athlete;
extracting selected characteristics from the received first data stream;
extracting the selected characteristics from the received second data stream;
determining a relationship between the extracted characteristics of the first and second data streams; and
determining a similarity score between the first athlete and the second athlete by comparing the determined relationship.

9. The method of claim 8, wherein said determining the relationship between the extracted characteristics comprises generating a first time series of body part positions of selected body parts of the first athlete and generating a second time series of body part positions of the selected body parts of the second athlete, said determining the relationship is based on the first and second time series.

10. The method of claim 9, wherein said generating the first time series and the second time series comprises generating a first time series of joint positions of the first athlete and generating a second time series of joint positions of the second athlete.

11. The method of claim 8, wherein said receiving a first data stream of a first athlete further comprises receiving video data of the first athlete.

12. The method of claim 11, further comprising extracting images of the first athlete from the received first video stream to remove background images, the extracted images of the first athlete used for said extracting selected characteristics.

13. The method of claim 8, further comprising aligning the received first and second data streams to a common reference point in time.

14. The method of claim 8, further comprising maintaining a derived indices, the derived indices being used to identify the selected characteristics for said extracting.

15. A computer system for comparing athletic performance metrics, comprising:
an analytics processing platform for receiving a first video stream of a first athlete from a sporting venue and for receiving a second video stream of a second athlete outside the sporting venue; and
a server system in operable communication with the analytics processing platform for extracting selected characteristics from the received first video stream, extracting the selected characteristics from the received second video stream, determining a relationship between the extracted characteristics of the first and second video streams, and determining a similarity score between the first athlete and the second athlete by comparing the determined relationship.

16. The system of claim 15, wherein said server system further generates a first time series of positions of selected body parts of the first athlete and a second time series of the selected body parts of the second athlete, the determining of the relationship is based on the first and second time series.

17. The system of claim 16, wherein said server system further generates a first time series of joint positions of the first athlete and generates a second time series of joint positions of the second athlete.

18. The system of claim 15, wherein said analytics processing platform further receives sensor data from sensors worn on the first athlete.

19. The system of claim 15, wherein said analytics processing platform extracts images of the first athlete from the received first video stream to remove background images, the extracted images of the first athlete used for the extracting selected characteristics.

20. The system of claim 15, wherein said server system maintains a derived indices, the derived indices being used to identify the selected characteristics for said extracting.
